(19) United States
(12) Patent Application Publication
(10) Pub. No.: US 2010/0268550 A1
(43) Pub. Date: Oct. 21, 2010

(54) Prescription messenger

(76) Inventors: Patrick Abuzeni, Key Biscayne, FL (US); Roger D. Perryman, Sunny Isles, FL (US)

Correspondence Address: John Sotomayor, 106 Spring Needle Ct., Cary, NC, 27513, US

(21) Appl. No.: 12/386,217

(22) Filed: Apr. 15, 2009

(51) Int. Cl. G06Q 50/00; G06F 17/30

(52) U.S. Cl. 705/3; 705/2; 707/E17.005; 707/E17.001

(57) ABSTRACT

The transfer of prescription medication requests from a physician to an individual is automated through the use of a clearinghouse function that interacts with both the physician and client. Maintaining the security of prescriptions, while simultaneously providing the advantages of electronic transfer is met the secure transmission of prescription information to a clearinghouse and the generation of a prescription that a user may then take to any pharmacy that is in communication with the clearinghouse. The prescription is only issued after the physician is verified by the clearinghouse as a valid prescription author, and the prescription is generated without sensitive data such that security is maintained if the prescription is lost. The clearinghouse, when contacted by a validated pharmacy, will issue information regarding the prescription when a valid, non-expired prescription identifier is entered into the system to the pharmacy. The user may then have the prescription filled without worry about validity or security of their personal data.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

Currently, prescription medication is given to a patient by a doctor through the use of the ubiquitous prescription pad. Prescriptions are written by the doctor and given to a patient to get filled at the nearest pharmacy. Systems that wish to provide a little more security may use a client/server based application to write a prescription and have the client application send the prescription to a secure server located at a pharmacy or other medication dispensation facility. In either case, a prescription is provided to a patient that contains patient information as well as medication and dosage information and is irrevocably connected with a particular favored medication dispensation facility.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a layout of the prescription interaction consistent with certain embodiments of the present invention.

FIG. 2 is a view of prescription message traffic between the patient, pharmacy and an electronic clearinghouse consistent with certain embodiments of the present invention

FIG. 3 is a flow layout of doctor validation with a prescription clearinghouse consistent with certain embodiments of the present invention.

FIG. 4 is a flow layout for the generation and presentation of prescriptions consistent with certain embodiments of the present invention.

FIG. 5 is a flow layout for the validation of a prescription with the electronic clearinghouse consistent with certain embodiments of the present invention.

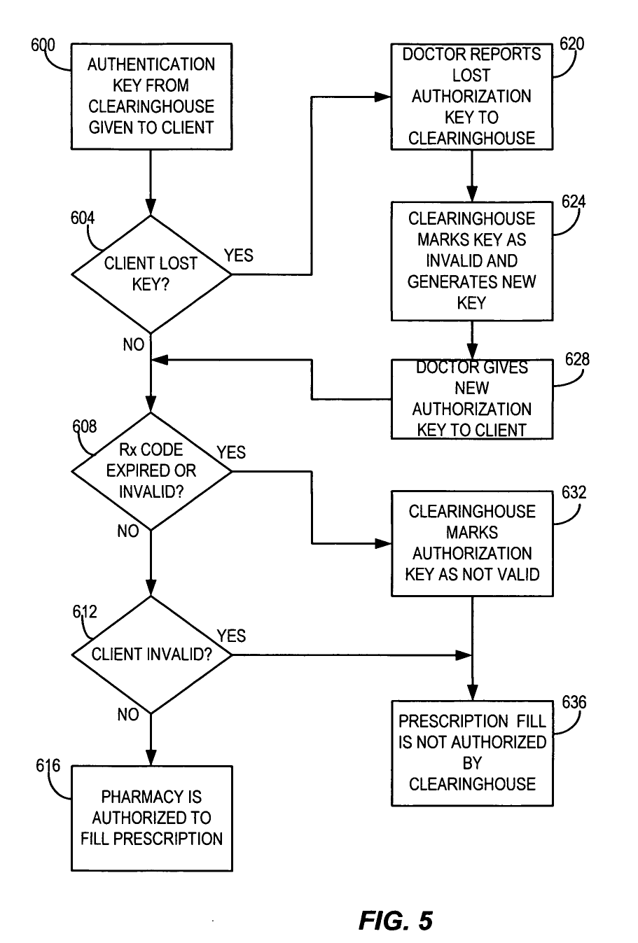

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one, or more than one. The term “plurality”, as used herein, is defined as two, or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The prescription messenger in an exemplary embodiment may increase physician and patient access to any pharmacy without the need for a pre-selected choice in the process of filling prescriptions, using an electronic communications medium and while preserving the security of both the prescription and client. When a patient visits a physician and the physician determines a patient need for a medication, the physician will create a prescription for that patient by establishing communication with an electronic clearinghouse dedicated to the secure creation and management of prescription services to physicians and pharmacies. In the exemplary embodiment a physician first authenticates with the clearinghouse that they are registered with the electronic clearinghouse, that their identity is valid, and that they are legally entitled to generate prescriptions. Once authenticated, the physician will be allowed to create or update a prescription record. After prescription data is created, the clearinghouse generates a randomized unique identification code as an secure authentication key for the prescription. The prescription secure authentication key can then be printed on the physician's usual prescription pad form. The data for medication and dosage is explicitly omitted to prevent filling of the prescription without first authenticating with the clearinghouse. The physician then provides the authentication key to the patient and the patient may later have the prescription filled at a medication dispensation facility of their choice, such as a pharmacy, hospital, or other licensed facility.

In the exemplary embodiment, no pharmacy is pre-selected in the process. After receiving the printed authentication key from their physician, the patient may take it to a pharmacy of their choosing. The only caveat is that the printed prescription with the authentication key must be presented to a pharmacy that subscribes to the electronic prescription clearinghouse. When a pharmacy that subscribes to the electronic clearinghouse receives the prescription, the pharmacy will then authenticate with the clearinghouse to access the patients prescription using the unique authentication key. Once accessed, the prescription data is flagged as having been either filled or invalidated (where invalidation may be caused by an invalid prescription number, a prescription that has expired, or be judged invalid for any other cause such as fraud, incorrect identification, an injunction against patient or physician, or any other validation inconsistency) by the clearinghouse and is no longer available to other pharmacies. If the prescription is invalidated for any reason, the electronic clearinghouse sends a mandatory notification of the invalidation, and reason for the invalidation, to the physician over a secure communications channel. If the prescription authorization code is valid, the electronic clearinghouse then sends the prescription details regarding the medication and dosage, as well as patient identification information, to the authorized pharmacy. It is the responsibility of the pharmacy filling the prescription to verify the patient identification information prior to releasing the filled prescription, which may be accomplished in any method consistent with pharmacy practices. The electronic clearinghouse may also send a notification to the physician that the prescription has been presented, if the physician is a subscriber to an optional notification service managed by the electronic clearinghouse. If the pharmacy receiving the prescription data has the medication on hand, the pharmacy may then fill the prescription for the patient. If the pharmacy with access does not have the medication on hand, it may return the secure authentication key to the clearinghouse so that the prescription may be filled by another validated pharmacy.

In this exemplary embodiment, filling a prescription through the use of the prescription messenger allows a physician to create prescriptions through the electronic clearinghouse that preserve the privacy of the patient and the type and amount of any medication they are taking. In addition, the prescription messenger provides patients with the flexibility of choosing any pharmacy that subscribes to the electronic clearinghouse for filling their prescription. The prescription messenger also provides a mechanism for pharmacies to access prescription data and automatically update prescription status in a forum that is accessible to all subscribing physicians and pharmacies, as well as, allowing pharmacies to perform a quick query to inquire about the basic prescription parameters, such as medication and dosage, to provide for a verification against pharmacy inventory prior to dispensing any medication.

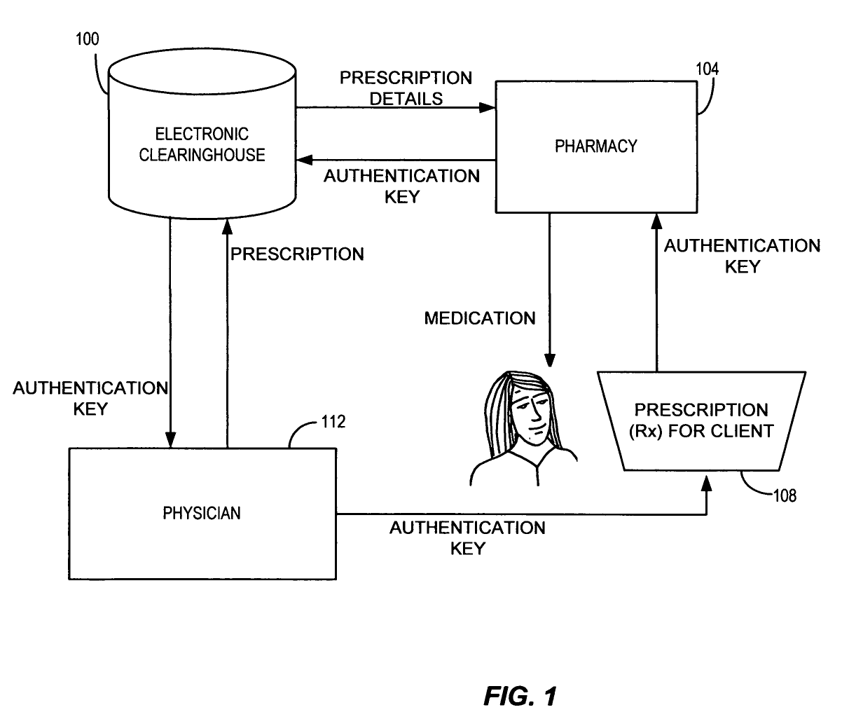

Turning now to FIG. 1, in an exemplary embodiment the implementation of the prescription messenger is presented at a level of communication interaction between the components of the system as a whole. A prescription 108 is generated by a physician 112 for a patient upon the patient's visit to the physician. Prior to generating the Prescription 108 the physician 112 establishes communication across a secure communication channel with an electronic clearinghouse 100 established to manage the interaction for the creation and management of a large number of Prescriptions. Once the physician 112 has contacted the electronic clearinghouse 100, the physician 112 must provide information to the electronic clearinghouse 100 to validate the physician 112 as authorized to generate prescriptions without restrictions, or, if restrictions apply, the authorization is set at a level of prescriptions the physician 112 is authorized to generate. After the physician 112 has been successfully authorized, he/she transmits the information required to create a valid Prescription.

Upon receipt of the Prescription information, the electronic clearinghouse 100 generates a secure authentication key for the prescription and transmits this authentication key to the physician 112 across the same secure communication channel. The physician 112 then prints the authentication key on a regular prescription pad form. The prescription authentication key printed on prescription pad does not contain any patient or medication information, but instead consists of the physician information, the encrypted authorization code provided to the physician by the clearing house, and any other physician specific information pre-authorized by the physician. As a non-limiting example, a physician authorized by the Drug Enforcement Agency (DEA) to prescribe narcotics my choose not to have their DEA license printed on the prescription pad form. The prescribing physician's DEA license information will always be available at electronic clearinghouse and the physician may choose, upon setting up their account with the electronic clearinghouse, whether to print this information or not. Once printed, the pharmacy provides the prescription form with the secure authentication key to the patient. Since, the printed prescription does not contain any patient information, the authentication key decouples the prescription from the patient through the use of the authentication key. This decoupling of prescription information from patient information assists in maintaining the privacy of the patient. Additional privacy and security concerns will be discussed later in connection with further non-limiting embodiments of the system.

In a further embodiment, the patient is now free to take the printed prescription containing the secure authentication key to any pharmacy 104, or other facility, such as a hospital or discount store having a license to dispense prescriptions, that is enrolled with the electronic clearinghouse 100. A Registered Pharmacist, or a Pharmacist Technician under the supervision of a Registered Pharmacist, at the pharmacy 104, upon receipt of the authentication key from the patient, will establish communication over a secure communication channel with the electronic clearinghouse 100 and provide credentials of the pharmacy membership. Once authorized, the pharmacy 104 may transmit the authentication key to the electronic clearinghouse 100. In addition, physicians who are subscribers to an optional notification service provided by the electronic clearinghouse 100 may receive a notification that the prescription has been presented to the electronic clearinghouse 100 for fulfillment. The electronic clearinghouse 100 validates the authentication key and returns the prescription 108 information to the pharmacy 104, allowing the pharmacy 104 to fill the Prescription 108 and provide the medication to the patient. Once again, notification of the fulfillment of the prescription may also be provided to physicians subscribing to the electronic clearinghouse 100 optional notification service.

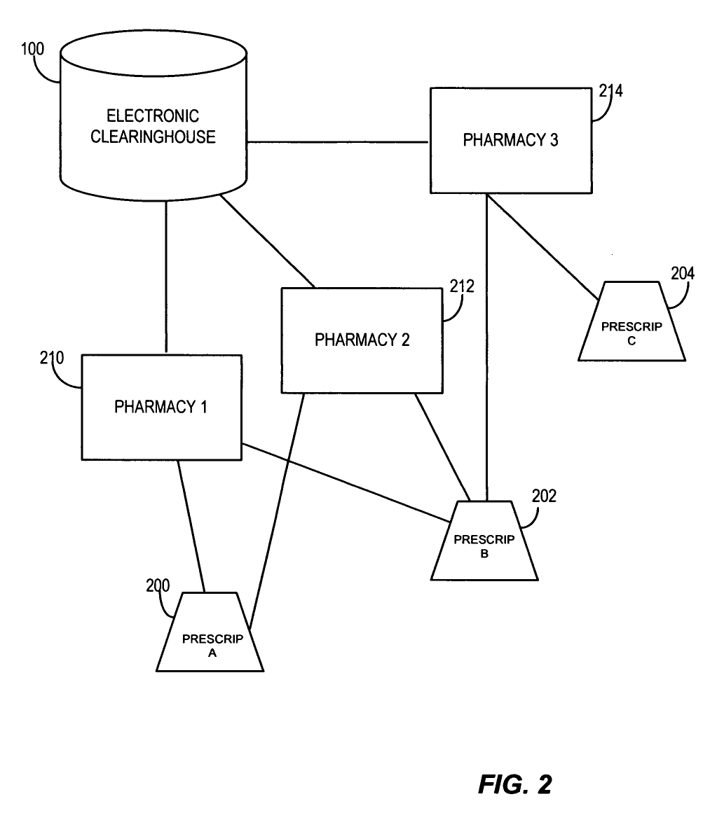

Turning to FIG. 2, in an exemplary embodiment each prescription 108 generated by a physician 112 authorized through the electronic clearinghouse 100 may be presented for fulfillment at any pharmacy (104, 210, 212, 214) that is enrolled with the electronic clearinghouse 100. In this embodiment, since the printed prescription does not provide any data or identification connection between the patient and the prescription 108 information until presented at the electronic clearinghouse, the freedom to present an authentication key at any enrolled pharmacy (210, 212, 214) provides the patient with data privacy with regard to the prescription 108 should the authentication key become lost. In addition, if a pharmacy (104, 210, 212, 214) does not have the appropriate medication, or does not have the appropriate amount of medication, on hand to fulfill the prescription 108, the patient is free to take the printed prescription containing the secure authentication key to another enrolled pharmacy (210, 212, 214) for fulfillment with data security intact. In this embodiment, prescriptions (200, 202, 204) may be presented at any of a plurality of pharmacies (210, 212, 214) for fulfillment. If, in an example of a possible scenario, printed prescription B 202 were to be presented for fulfillment to pharmacy 1 210 and pharmacy 1 210 did not have the medication on hand, printed prescription B 202 would be returned to the patient and the Registered Pharmacist, or Pharmacist Technician, must return the unique encrypted authorization code contained within printed prescription B 202 to the clearinghouse with the indication that prescription B 202 associated with that unique authentication key has not been filled and the authentication key is to be released such that it may be fulfilled by another pharmacy. The patient would then be free to present printed prescription B 202 to pharmacy 2 212. If pharmacy 2 212, in this non-limiting example, were not able to fulfill printed prescription B 108 for any reason, the printed prescription B 202 would once again be returned to the patient, and the unique authentication key contained within printed prescription B 202 would be released by the pharmacy, and printed prescription B 202 could then be presented for fulfillment at pharmacy 3 214. At the point that the prescription 108 is fulfilled, the electronic clearinghouse 100 may send a notification of the fulfillment of the prescription 108 to the prescribing physician, if the physician is a subscriber to the notification service of the electronic clearinghouse 100. The patient is assured that, since the prescription 108 details are managed and communicated between the electronic clearinghouse 100 and the pharmacies (210, 212, 214), their personal information is never exposed outside of the pharmacy, and, if printed prescription B 202, for example, is lost, a finder of the printed prescription B 202 may not use printed prescription B 202 to learn anything about the patient. In addition, because of patient identification procedures of each pharmacy, a person not authorized by the patient may not clandestinely receive the patient's medication instead of the patient.

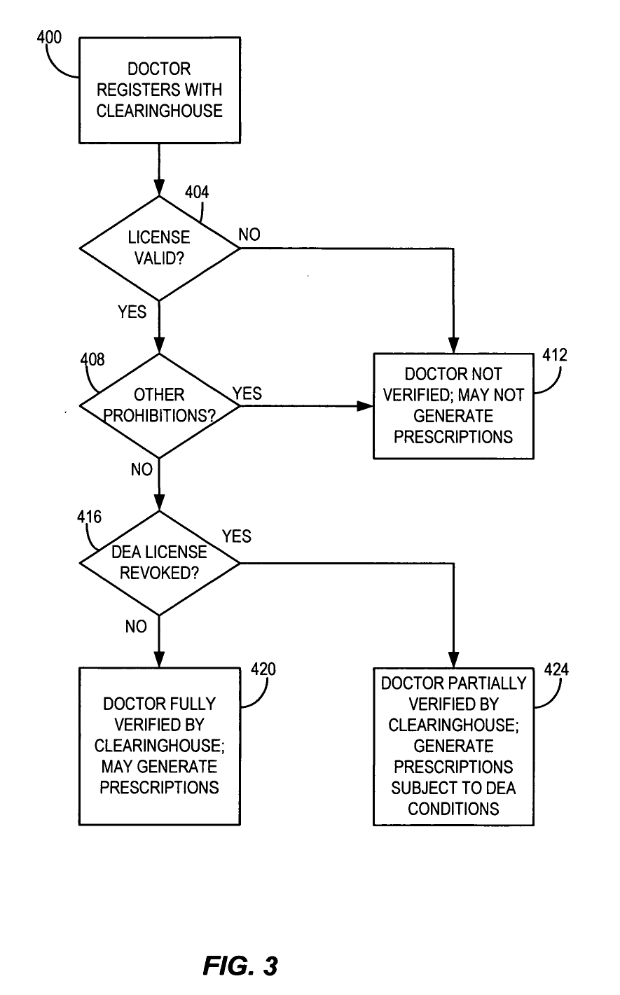

Turning now to FIG. 3, the process of the validation of a physician 112 with the electronic clearinghouse 100 is discussed within an exemplary embodiment. As an initial condition, the physician 112 registers with the electronic clearinghouse 100 and provides credentials for validation 400. The electronic clearinghouse 100, as a primary area of responsibility, will need to validate the credentials provided by the physician to ensure that the physician 112 has a current and valid license 404 to dispense medication. If the physician 108 cannot be validated for any reason, the electronic clearinghouse 100 will place an internal notification flag in association with that physician's name that the physician 108 is not authorized and may not generate prescriptions 412. In addition, the electronic clearinghouse 100 will automatically generate and send a mandatory notification to the physician to inform the physician that they are not authorized to generate prescriptions through the electronic clearinghouse 100 and the reason for the denial of authorization. The electronic clearinghouse 100 performs this authorization and license validation activity each time a physician is added to the clearinghouse data store and each time a prescription authorization code is presented to the electronic clearinghouse 100 from a qualified pharmacy 104, and manages this data for relevance on an ongoing basis such that the authorization of a physician 108 is maintained and updated with the most current information available.

As part of the physician validation, the electronic clearinghouse 100 is also responsible to determine if there are other prohibitions 408 against the physician 108 seeking to register with the electronic clearinghouse 100 or prescribe medication through the electronic clearinghouse 100. Other prohibitions may include temporary revocation of a physician's license for disciplinary reasons, permanent revocation of the physician's license, or any other manner in which licensure has been suspended or revoked by the state or federal authority charged with maintaining physician licenses. If other prohibitions exist 408, then the physician 108 cannot be authorized by the electronic clearinghouse 100 and the physician will not be allowed to generate prescriptions 412 through the electronic clearinghouse 100.

In addition to licensure revocation, the electronic clearinghouse 100 will validate the physician 108 for license restrictions. In a non-limiting example, the electronic clearinghouse will seek to determine whether the Drug Enforcement Agency (DEA) has revoked the physician's license to prescribe narcotics 416. If the physician's license has been revoked by the DEA, the physician may still be authorized to prescribe other medications. Thus, in this non-limiting example, the electronic clearinghouse 100 will partially authorize the physician to generate prescriptions 412, with the prohibition that the physician 108 may prescribe medication subject to DEA conditions 424. A mandatory electronic notification of any license restrictions will be sent to the physician across a secure communication channel upon the discovery of such license restrictions by the electronic clearinghouse 100.

After the electronic clearinghouse 100 has completed the validation of the physician's credentials, and determined that there are no revocation or restriction actions against the physician 108, the physician 108 is authorized by the electronic clearinghouse 100 to generate prescriptions 420.

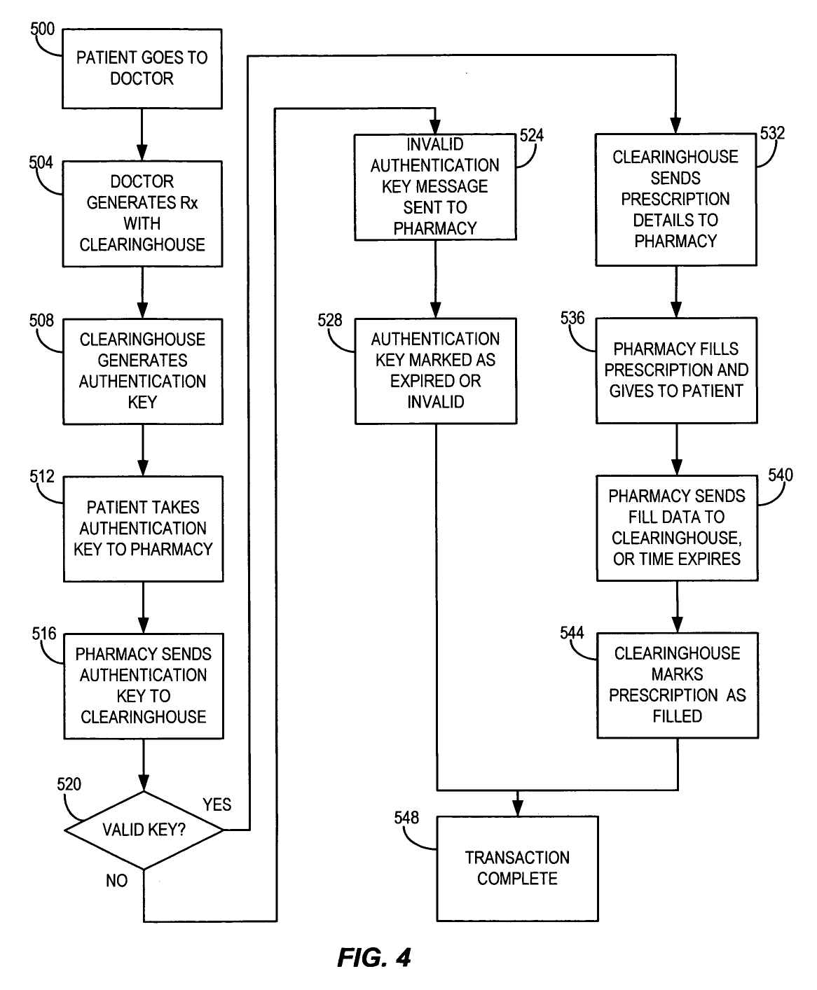

Turning now to FIG. 4, an exemplary embodiment for a patient transaction is presented. The Patient visits a physician of their choice 500. The physician has been authorized to generate an prescription 420 in compliance with the non-limiting example presented in FIG. 3. The physician 108 establishes communication across a secure communication channel to the electronic clearinghouse 100 through the use of any registered 3rd party application or device which can communicate over the internet via a secure connection and exchange electronic messages. The physician 108 enters their authorized Login ID and Password established with the electronic clearinghouse 100. In compliance with the electronic clearinghouse 100 physician licensure update process, the electronic clearinghouse 100 will attempt to validate the physician logon against the updated records of the physician licensure status. The electronic clearinghouse 100 will accept the physician logon if there are no current or pending licensure revocation or restriction actions, and the physician logon data are correct. The electronic clearinghouse 100 will reject the logon attempt if the logon data are incorrect, or if the physician's credentials have been revoked.

Once successfully logged in to the electronic clearinghouse, the physician enters the prescription information composed in part of patient and medication details and transmits it to the electronic clearinghouse to generate a prescription 504. The physician 108 may submit prescriptions individually or as a group of prescriptions to be generated simultaneously. The electronic clearinghouse verifies with the physician 108 that the correct information was transmitted through a question and response electronic dialog with the physician 108. The electronic clearinghouse 100 verifies that the physician 108 is authorized to write the prescription for the medication specified in the transmission of the details for the prescription. In a non-limiting example, if the physician's DEA license is revoked, he cannot write narcotic prescriptions, or if subject to pending disciplinary action for any other reason, he cannot write prescriptions for any medication. A mandatory notification message will be sent by the electronic clearinghouse 100 to the physician upon discovery of any license restrictions or revocations. Once validation of the prescription details and the physician 108 are complete, the electronic clearinghouse 100 stores the data for the prescription request, or batch of prescription requests, in its secure database.

In an exemplary embodiment, the electronic clearinghouse next generates a secure, encrypted authentication key 508. The authentication key is unique for each prescription request, whether the request is for a single prescription or a plurality of prescriptions are submitted as a group within a single request, such that multiple prescriptions may share the same authentication key. However, although the secure authentication key is unique, in a non-limiting example a medication identifier may be appended to the authentication key printed on the prescription form to indicate separate prescribed medications within a plurality of prescriptions that have been submitted as a group within a single request. Thus, in this non-limiting example, if the secure authentication key is represented by AABBCCDD for the group, then each individual prescription would be represented by AABBCCDD-1, AABBCCDD-2 . . . AABBCCDD-n, where n is the total number of prescriptions contained within a group prescription request. Thus, there is provided for each medication in the group prescription a single authentication key with an individualized medication identifier appended to the authentication key, forming a uniques prescription identifier for each medication in the group. In an exemplary embodiment the authentication key may expire after a pre-determined period of time. In a non-limiting example the expiration time period could be set for 30 days, or for any time period that experience determines is sufficient for the redemption of the average prescription without causing hardship on the patients.

After the physician 108 receives the authentication key, the physician 108 may print the prescription authentication key, including any sub-authentication key values, on a regular prescription pad form. The patient information is intentionally omitted from the printed prescription. In addition to the authentication key, a bar code will be printed on the prescription pad form to simplify the data entry at the authorized pharmacy 104. The patient may then visit the enrolled, authorized pharmacy of their choice for fulfillment of the prescription. In a non-limiting example, the physician 108 may provide the patient with a list of pharmacies nearby that are so enrolled. The patient receives the printed prescription from the physician and provides the authentication key, to an enrolled pharmacy 104 for fulfillment 512.

The pharmacy 104 connects to the electronic clearinghouse 100, once again across a secure communication channel such as a network connection with a secure encryption service for data transmissions. The pharmacy 104 is validated by the electronic clearinghouse 100 as being properly enrolled and the pharmacy transmits the encrypted authorization code 516 to the electronic clearinghouse 100.

In an exemplary embodiment, the electronic clearinghouse 100 receives the transmitted encrypted authentication key and validates the authentication key and prescription 520. The electronic clearinghouse 100, in a non-limiting example, may verify that the prescription requests are valid by checking the authentication key for any data entry errors 524 as a part of the authentication key authorization action. If the authentication key is valid, the electronic clearinghouse may also determine whether the prescription was already filled, has expired, or was never before submitted 528.

If the prescription is determined by the electronic clearinghouse 100 to be valid and not yet fulfilled, then, for each valid prescription, the patient and prescription information is returned to the pharmacy 532. The pharmacy 104 will then fill the prescription using the details transmitted from the electronic clearinghouse 100 and present the medication to the patient 536 after verifying, in compliance with standard pharmacy patient identification procedures, that the individual receiving the prescription is the patient, or is authorized by the patient to receive the medication. The pharmacy 104 may then send a confirmation of the filling of the prescription 540, or may simply move on to the next transaction. If the pharmacy 104 does not send a confirmation of fulfillment, the prescription will be assumed filled by the electronic clearinghouse 100 and the prescription record will be updated as submitted such that the prescription can no longer be filled 544.

In the exemplary embodiment, the electronic clearinghouse 100 may provide a service by subscription where prescription event notification from the electronic clearinghouse may be provided to subscribing physicians and pharmacies. The event notification may provide information to such subscribers as to when prescriptions are presented for fulfillment, when they have been fulfilled, when they have expired, when they have been released prior to being fulfilled, as well as other conditional information regarding the status of prescriptions either generated by a subscribing physician, or presented for fulfillment by a participating pharmacy. The subscription service may also provide summary information on a per-time-period basis and provide subscribers with summary and other metric data regarding prescriptions written, prescriptions that have been invalidated, unfulfilled, expired, and other summary information for the past representative time period. This service would be managed by the electronic clearinghouse 100 and would require a sign up process in addition to signing up with the electronic clearinghouse 100 to write or fulfill prescriptions.

In the event the pharmacy 104 is unable to fill the prescription, the pharmacy 104 will notify the electronic clearinghouse 100 that the prescription has not been filled and return the secure authentication key to the electronic clearinghouse 100. Upon the receipt of the secure authentication key the electronic clearinghouse 100 will change the prescription status back to “fillable” for any prescription requests that were returned by the pharmacy 104. The change update in the electronic clearinghouse 100 may also update the database to reflect those prescriptions that were filled from within a plurality of prescriptions filed as a single group prescription. In a non-limiting example, if an authorized pharmacy 108 receives a secure authentication key from a patient that references a group prescription containing three separate medications, the secure authentication key will have a separate medication identifier appended to the secure authentication key for each medication in the group consistent with the prescription identifier disclosed above. The electronic clearinghouse 100 will flag those prescription identifiers that the pharmacy has fulfilled with a “filled” flag, and mark the prescription identifiers that have not been fulfilled as available for fulfillment. In this manner, the patient may take the authentication key to another authorized pharmacy and have only those medications that were not dispensed by the first pharmacy fulfilled at the second pharmacy.

A log entry will be created at the electronic clearinghouse 100 and within the 3^{rd} party interface application indicating that the pharmacy 104 attempted to fill the prescription but was unable to do so. In addition, the electronic clearinghouse 100 may generate and send a notification message to the physician associated with the prescription, if the physician is a subscriber to the optional notification service available from the electronic clearinghouse 100.

Turning now to FIG. 6, this figure presents an exemplary embodiment of the use of the prescription by the patient. The printed prescription, containing physician identification, and other physician authorized, information and a secure authentication key, is printed upon a standard prescription pad form and given to the patient 600. The printed prescription does not contain patient or medication information, and does not print this information on the standard prescription form. If, prior to presentation at an enrolled pharmacy 108, the patient loses the printed prescription (which contains the secure authentication key assigned by the electronic clearinghouse 100 as a portion of the printed information) 604, the patient or the pharmacist must contact the physician 108. The physician 108 may then contact the electronic clearinghouse 100 to update the prescription record with the electronic clearinghouse 100 such that the prescription record maintained within the secure data storage within the electronic clearinghouse may be updated 620 to reflect the fact that the authentication key has been lost and the secure authentication key should be voided within the electronic record maintained for the prescription. The electronic clearinghouse may then void the original secure authentication key and issue a newly generated secure authentication key 624 to preserve the security of the patient's medical information and yet continue to allow the patient the opportunity to fulfill the prescription. The electronic clearinghouse 100 then issues the new authentication key to the physician 108 and the physician 108 may then issue the newly generated authentication key to the patient 628 as printed on the prescription form.

Once the patient presents the authentication key to a pharmacy 104, the pharmacy 104 sends the authentication key across a secure communications channel to the electronic clearinghouse 108. The electronic clearinghouse then attempts to retrieve the record for the prescription using the authentication key and attempts to validate the prescription. If the authentication key does not match any existing record in the data storage, the electronic clearinghouse may determine that the authentication key is invalid 608. In this instance, the electronic clearinghouse 100 will mark the authentication key as invalid 632 and will not issue prescription details to the pharmacy. The pharmacy will be unable to fulfill the prescription at that time.

If the authentication key is determined to be valid by the electronic clearinghouse, the electronic clearinghouse 100 will validate the prescription. The electronic clearinghouse 100 will also perform a validation that the patient has a pre-existing record 612 within the subscribing physicians 108 records for prescriptions stored within the secure database in the electronic clearinghouse 100. The lack of a patient record for that prescription may indicate that someone, such as a hacker, is trying to guess an authentication key. When this occurs, the electronic clearinghouse will not validate the authentication key and will send a notification to the pharmacy that the patient is not recognized and that the physician 108 must be notified. The electronic clearinghouse may then mark the prescription as pending validation by the physician 108.

If the prescription is determined to be invalid, pending, or expired the prescription is not authorized and the electronic clearinghouse 100 transmits a denial to the pharmacy, transmitting the secure authorization code originally sent 636. If, however, all validation checks for the authentication key and the patient are verified, the electronic clearinghouse authorizes the pharmacy 104 to fill the prescription 616 and sends the appropriate prescription details, including medication and patient details to the pharmacy 104 for fulfillment. The electronic clearinghouse 100 may also send information regarding any patient drug allergies, or information concerning any drug interaction notifications that may be indicated based upon the electronic clearinghouse 100 records of additional medications that the patient may have already been prescribed and had fulfilled.

While certain illustrative embodiments have been described, it is evident that many alternatives, modifications, permutations and variations will become apparent to those skilled in the art in light of the foregoing description.

What is claimed is:

1. A method for fulfilling a secure prescription, comprising:
initializing a secure communications channel between a physician and an electronic clearinghouse comprising a secure database of prescription information;
transmitting a request using the secure communications channel to create a new prescription record within the secure database of prescription information;
generating the new prescription record and an authentication key, the authentication key transmitted from the electronic clearinghouse to the physician;
providing the authentication key from the physician to a patient, wherein the prescription comprises a record with no associated patient information;
presenting the secure authentication key to a pharmacy for later presentation to the electronic clearinghouse;
validating the authentication key by the electronic clearinghouse after presentation of the authentication key to the electronic clearinghouse; and
wherein the retrieved prescription information is supplied to the pharmacy for fulfillment.

2. A method as in claim 1, wherein the validated authentication key permits the electronic clearinghouse to retrieve the prescription medication and patient data from the secure database of prescription information.

3. A method as in claim 2, wherein the electronic clearinghouse comprises validation and management processes to maintain the privacy of patient information comprising patient identification and patient medication information.

4. A method as in claim 1, wherein a printed prescription comprises physician identification information, physician authorized information, and a secure authentication key.

5. A method as in claim 4, wherein the printed prescription is created without patient information of any type and is provided to the patient.

6. A method as in claim 1, wherein the physician and pharmacy must be enrolled with the electronic clearinghouse to access the secure prescription creation process.

7. A method as in claim 6, wherein the physician and pharmacy are each validated by the electronic clearinghouse validation process prior to initiating communication with either the physician or the pharmacy.

8. A method as in claim 1, wherein the prescription information supplied to the pharmacy for fulfillment of the prescription comprises detailed patient and patient medication information retrieved from the secure database of prescription information sufficient to complete the fulfillment.

9. A system for fulfilling a secure prescription, comprising:
a processor;
a secure communications channel for initializing secure communications between a physician and an electronic clearinghouse;
a storage device operative to maintain a secure database of prescription information;
a module operative for transmitting a request using the secure communications channel to create a new prescription record within the secure database of prescription information;
a module operative for generating the new prescription record within the secure database stored within the electronic clearinghouse and an authentication key that is transmitted from the electronic clearinghouse to the physician;
a module operative for providing the prescription from the physician to a patient, wherein the prescription comprises the authentication key with no associated patient information;
a module operative for communicating the authentication key to a pharmacy for later presentation to the electronic clearinghouse;
a module operative for validating the authentication key by the electronic clearinghouse after presentation of the authentication key to the electronic clearinghouse; and
wherein the prescription information retrieved from the storage device comprising the secure database of prescription information is supplied to the pharmacy for fulfillment.

10. A system as in claim 9, wherein the validated authentication key permits the electronic clearinghouse to retrieve the prescription medication and patient data from the secure database of prescription information stored within the storage device.

11. A system as in claim 9, wherein the electronic clearinghouse comprises validation and management processes to maintain the privacy of patient information comprising patient identification and patient medication information.

12. A system as in claim 11, wherein the physician and pharmacy in communication with the electronic clearinghouse must first be registered with the electronic clearinghouse as agents authorized to transmit and receive authentication key information.

13. A computer readable storage medium comprising computer-executable instructions for fulfilling a secure prescription, comprising:
initializing a secure communications channel between a physician and an electronic clearinghouse comprising a secure database of prescription information;
transmitting a request using the secure communications channel to create a new prescription record within the secure database of prescription information;
generating the new prescription record and an authentication key, the authentication key transmitted from the electronic clearinghouse to the physician;
providing the authentication key from the physician to a patient, wherein the prescription comprises a record with no associated patient information;
presenting the secure authentication key to a pharmacy for later presentation to the electronic clearinghouse;
validating the authentication key by the electronic clearinghouse after presentation of the authentication key to the electronic clearinghouse; and
wherein the retrieved prescription information is supplied to the pharmacy for fulfillment.

14. The computer readable medium of claim 13, wherein the validated authentication key permits the electronic clearinghouse to retrieve the prescription medication and patient data from the secure database of prescription information.

15. The computer readable medium of claim 14, wherein the electronic clearinghouse comprises validation and management processes to maintain the privacy of patient information comprising patient identification and patient medication information.

16. The computer readable medium of claim 13, wherein a prescription further comprises physician identification information, physician authorized information, and a secure authentication key.

17. The computer readable medium of claim 13, wherein the authentication key is created without patient information of any type and is provided to the physician in this manner.

18. The computer readable medium of claim 13, wherein the physician and pharmacy must be enrolled with the electronic clearinghouse to access the secure prescription creation process.

19. The computer readable medium of claim 18, wherein the physician and pharmacy are each validated by the electronic clearinghouse validation process prior to initiating communication with either the physician or the pharmacy.

20. The computer readable medium of claim 13, wherein the prescription information supplied to the pharmacy for fulfillment of the prescription comprises detailed patient and patient medication information retrieved from the secure database of prescription information sufficient to complete the fulfillment.
